(19) United States
(12) Patent Application Publication
(10) Pub. No.: US 2023/0327754 A1
(43) Pub. Date: Oct. 12, 2023

(54) METHOD OF OPERATING A SATELLITE COMMUNICATIONS TERMINAL

(71) Applicant: All.Space Networks Limited, Reading (GB)

(72) Inventors: Brian Murphy Billman, Baltimore, MD (US); Jeremiah P. Turpin, Linthicum, MD (US); John Finney, London (GB)

(73) Assignee: All.Space Networks Limited, Reading (GB)

(21) Appl. No.: 18/132,005

(22) Filed: Apr. 7, 2023

Related U.S. Application Data
(60) Provisional application No. 63/328,902, filed on Apr. 8, 2022.

(51) Int. Cl. H04B 7/185; H04W 76/16

(52) U.S. Cl. CPC H04B 7/18563; H04W 84/06; H04W 76/16

(57) ABSTRACT

A method of operating a satellite communications terminal. The method comprises analysing data to be communicated through the satellite communications terminal to identify separate data streams and to determine a data stream parameter characterising each data stream, identifying a plurality of communications links available through the satellite communications terminal comprising a satellite communications link and one or more further communications links, determining a link parameter characterising each available communications link, selecting at least two communications links from the available communications links and establishing or maintaining simultaneous connections to each selected communications link; and transmitting a first data stream through a first selected communications link and transmitting a second data stream through a second selected communications link, wherein the selection of at least two communications links is based on the data stream parameters characterising the first and second data streams and the link parameters characterising the available communications links.

### CROSS-REFERENCE TO RELATED APPLICATIONS

The present application claims the benefit under 35 U.S.C. § 119(e) of U.S. Provisional Patent Application Ser. No. 63/328,902, filed Apr. 8, 2022, and entitled “METHOD OF OPERATING A SATELLITE COMMUNICATIONS TERMINAL,” which is hereby incorporated by reference herein in its entirety.

### TECHNICAL FIELD

The present disclosure relates to a method of operating a satellite communications terminal, in particular a satellite communications terminal in a satellite communications network with a satellite antenna. A further aspect of the present disclosure relates to a computer-readable storage medium having computer-readable program code stored therein that, in response to execution by a processor, causes the processor to perform the method of operating a satellite communications terminal. A yet further aspect of the present disclosure relates to a satellite communications terminal operable to perform the method.

### BACKGROUND

Satellite communication is a long-established technique permitting a terrestrial satellite terminal (which may be located on the ground or airborne) to connect to or communicate with another network location via a communications satellite. Messages may be relayed by a communications satellite to and/or from a satellite communications terminal. That is, the communication path may be unidirectional, for instance to the satellite terminal in the case of broadcast television. Or the communication path may be bi-directional, and hence support a broad range of services by the satellite terminal being configured to exchange messages with communications satellite.

### BRIEF SUMMARY OF THE DISCLOSURE

According to a first aspect, there is provided a method of operating a satellite communications terminal, the method comprising:
analysing data to be communicated through the satellite communications terminal to identify separate data streams and determine a data stream parameter characterising each data stream;
identifying a plurality of communications links available through the satellite communications terminal comprising a satellite communications link and one or more further communications links;
determining a link parameter characterising each available communications link;
selecting at least two communications links from the available communications links and establishing or maintaining simultaneous connections to each selected communications link; and
transmitting a first data stream through a first selected communications link and transmitting a second data stream through a second selected communications link;
wherein the selection of at least two communications links is based on the data stream parameters characterising the first and second data streams and the link parameters characterising the available communications links.

The selection of the at least two communications links may be based on predicted availability of the available communications links.

Each further communications link may be a satellite communications link. Each further communications link may be a terrestrial communications link.

The data stream parameter characterising each data stream may comprise one or more of type of data, required bandwidth, required latency, requirement for encryption and data priority.

The link parameter characterising each available communications link may comprise one or more of available bandwidth, latency, signal strength, connection point on the ground, network type, whether encrypted and whether the network is shared, private, dedicated, open or closed.

Determining the link parameters may comprise one or more of assessing:
current and predicted weather conditions that affect communications links;
blockage of at least part of the field of view of the satellite communications terminal;
interference affecting communications link performance;
predicted movement of the satellite communications terminal;
predicted movement of communications satellites; and
prior communications link performance.

Analysing data to be communicated through the satellite communications terminal to identify separate data streams and to determine a data stream parameter characterising each data stream may be performed by a network element with which the satellite communications terminal is in communication.

The method may comprise allocating the first and second data streams to the at least two communications links based upon the link parameters and the data stream parameters in accordance with data allocation protocols determined by an artificial intelligence module.

A first selected communications link may be operated in a first performance mode and a second selected communications link may be operated in a second performance mode, wherein the second performance mode has a higher throughput than the first performance mode and consumes more power than the first performance mode.

According to a second aspect, there is provided a method of operating a satellite communications terminal having a satellite antenna, the method comprising:
controlling the satellite antenna to generate a first beam to communicate with a first communications satellite according to one of at least first and second performance modes, wherein the second performance mode has a higher throughput than the first performance mode and consumes more power than the first performance mode;
wherein the method further comprises determining whether to communicate with the first communications satellite in the first or second performance mode on the basis of one of:
a measured link condition or a predicted link condition for communicating with the first communications satellite;
an indication of link congestion comprising a backlog of data to be transmitted to the first communications satellite;
a constraint to maintain average power consumption below a first threshold; and
a constraint to limit the maximum power level.

The measured link condition may comprise a signal to noise plus interference ratio. The measured link condition or predicted link condition may comprise an estimated uplink or downlink throughput for communicating with the first communications satellite.

The satellite communications terminal may monitor a volume of requested communications traffic, and the satellite communications terminal may switch from the first performance mode to the second performance mode when the volume of requested communications traffic exceeds the capacity of the first performance mode.

The satellite communications terminal may switch from the first performance mode to the second performance mode based upon performance mode selection protocols determined by an artificial intelligence module.

The satellite antenna may comprise a lens antenna array comprising:
a plurality of lens sets, each lens set including:
a lens:
plurality of feed elements aligned with the lens and each configured to direct a signal through the lens in different desired directions;
wherein the second performance mode comprises operating a larger number of feed elements per lens than the first performance mode.

The method may further comprise the satellite communications terminal communicating with the first communications satellite in a different performance mode from the determined first or second performance mode in response to a user override instruction.

According to a third aspect, there is provided a computer-readable storage medium having computer-readable program code stored therein that, in response to execution by a processor, cause the processor to perform the method of the first aspect, the second aspect, or both.

According to a fourth aspect, there is provided a satellite communications terminal comprising:
a satellite antenna;
a processor; and
a memory storing executable instructions that, in response to execution by the processor, cause the processor to perform the method of the first aspect, the second aspect, or both.

### BRIEF DESCRIPTION OF THE DRAWINGS

Examples are further described hereinafter with reference to the accompanying drawings, in which:

FIG. 1A shows a satellite communications terminal with communications links to communications satellites, terrestrial communications links and communication to another part of a communications network;

FIG. 1B shows a further satellite communications terminal in which communications links to some communications satellites are blocked or attenuated;

FIG. 2 shows data handling for transmission of a composite data stream;

FIG. 3 shows a partially exploded view of the lens array of a multiple beam phased array satellite antenna; and

FIGS. 4A and 4B illustrate transmission from a satellite antenna with different beam strengths.

### DETAILED DESCRIPTION

Like reference numerals refer to like elements throughout.

It is an aim of certain examples of the present disclosure to solve, mitigate or obviate, at least partly, at least one of the problems and/or disadvantages associated with the prior art. Certain examples aim to provide at least one of the advantages described herein. In particular, certain examples of the present disclosure seek to provide a method of operating a satellite communications terminal that is more robust, flexible and faster by selecting a plurality of communications links and simultaneously communicating different subsidiary data streams through respective communications links. Further, certain examples of the present disclosure seek to provide a method of operating a satellite communications terminal in which data communication speed is balanced against power consumption.

A method of operating a satellite communications terminal is disclosed in which a composite data stream is analysed and split into subsidiary data streams for communication over different communications links according to different characterising parameters of the subsidiary data streams and the communications links. Separating the composite data stream into a plurality of subsidiary data streams that are simultaneously transmitted by different communications links enables enhanced transmission performance, for example, reducing latency in video/voice communications and enhancing average data speed for transmission of large data files, may enhance total data throughput, increases communications link diversity, and so increases resilience, and enables continuous reprioritisation and reallocation between different communications links in response to real-time changes in the communications link conditions.

A method of operating a satellite communications terminal having a satellite antenna is disclosed, with a beam from the satellite antenna to a communications satellite, in which the beam is controlled in in one of a plurality of performance modes providing different levels of throughput and power consumption. Determining the performance mode of the beam enables the data throughput and receiver sensitivity to be matched to operational requirements, whilst limiting power consumption, and enables more rapid response to an increase in operational requirements than by establishing an additional link.

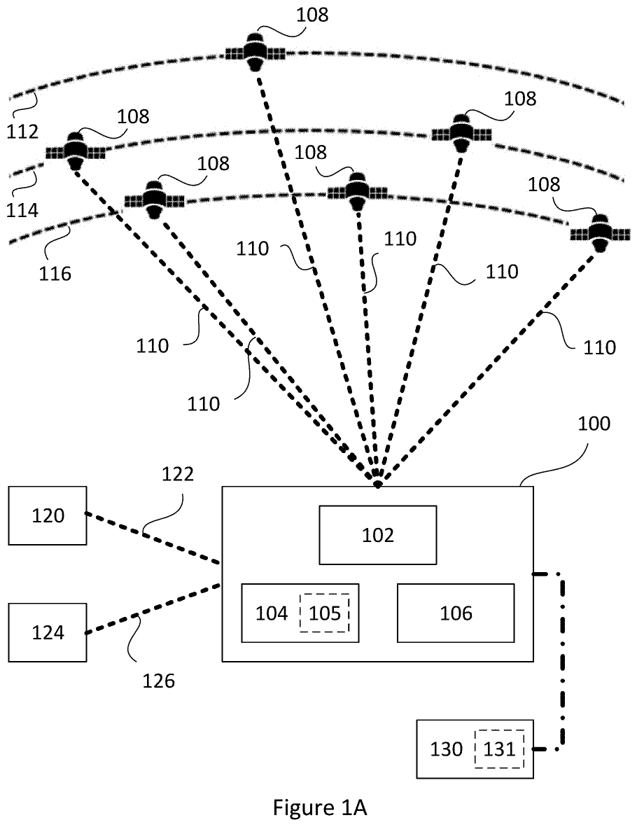

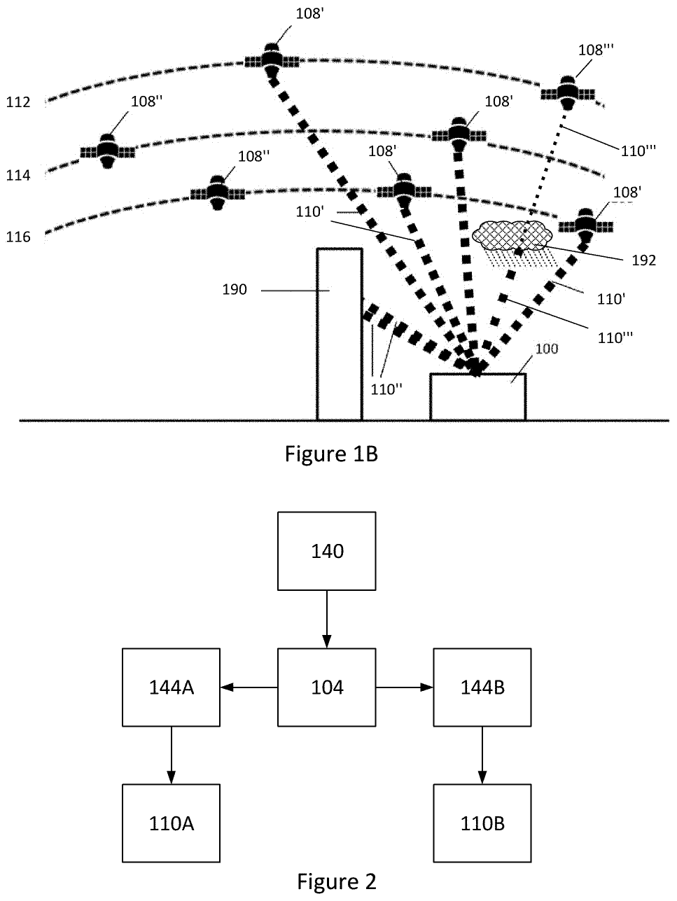

FIG. 1A illustrates a satellite communications terminal 100, and the flowchart of FIG. 2 illustrates a method of operating the communication terminal 100.

The satellite communications terminal 100 comprises a satellite antenna 102, a processor (controller) 104 and a memory 106 (computer-readable storage medium).

The satellite communications terminal 100 also comprises a modem, amplifiers, level shifters, and frequency converters for interconnecting communications signals to and from the modem and the satellite antenna 102. The satellite communications terminal 100 may also comprise one or both of a Wi-Fi communications antenna, a radio frequency antenna for communicating with a terrestrial cellular telephone communications network (e.g. 4G or 5G).

The memory 106 may comprise a satellite terminal database, or another network entity in the communications network (e.g. the network controller 130) may comprise a satellite terminal database. The communications terminal 100 is operable to locate communications satellites 108 and store information concerning those communications satellites in the satellite terminal database. The located communications satellites may be described as available communications satellites, in the sense that they are visible to the satellite communications terminal 100 and hence in principle are available for the satellite communications terminal to communicate with.

However, it will be appreciated that many other factors dictate whether a communications terminal 100 is able to communicate with a communications satellite 108, including for instance whether there is a commercial relationship between the operator of the communications terminal 100 and an operator of the communications satellite 108.

These factors would be identified by the user or by the communications terminal 100 inspecting and communicated (using a modem) to determine which satellites (or satellite constellations) are commercially available for communication with the communications terminal 100, or information on these factors may be communicated to the communications terminal 100 by a network controller 130.

The skilled person will be familiar with the construction and operation of a conventional satellite communications terminal 100 and operation of a conventional satellite communications network, and so detailed explanation of the features of a conventional satellite communications terminal 100 will not be provided here.

The communications terminal 100 makes use of the information within the satellite terminal database to inform decisions such as network routing.

The memory 106 is configured to store instructions that, in response to execution by the processor 104, cause the processor 104 to control the communications terminal 100 in accordance with the present examples.

The processor 104 controls the satellite antenna 102 to generate at least one beam 110 operable to search for and to transmit signals to the communications satellites 108. The satellite communications terminal 100 will also receive signals from the communications satellites 108. The present method is not restricted to any specific hardware implementation of a communications terminal 100, or a particular satellite antenna 102, beyond the requirement for the satellite antenna 102 to be operable to generate at least one beam for transmitting a signal to and receiving a signal from a communications satellite 108.

In some examples the satellite antenna 102 may be operable to generate only a single beam 110 at any one instance. In other examples the satellite antenna 102 may be a multiple beam satellite antenna 102, for instance operable to generate a first beam 110 for communicating with a first communications satellite 108, and to simultaneously generate at least a second beam 110 for searching for, or communicating with, one or more further communications satellites 108.

Alternatively, the satellite antenna 102 may be a plurality of single-beam antennas, forming part of a common multi-beam satellite communications terminal 100. In a further alternative, single-beam antennas may each form part of a respective single-beam satellite communications terminal, the single-beam satellite communications terminals being operable as a multi-beam satellite communications terminal 100.

The satellite antenna 102 may be a multibeam lens array, which is capable of operation to provide a plurality of beams.

FIG. 1A illustrates a plurality of communications satellites 108 each of which may communicate signals with the satellite communications terminal 100 using a satellite communications link (a “link”) on a respective beam 110. (The beam may carry multiple communications links, and each communications link may carry multiple communications channels.) The communications satellites 108 may be arranged in different orbits, for instance a geostationary orbit (GEO) 112, a medium Earth orbit (MEO) 114 and a low Earth orbit (LEO) 116. The communications terminal 100 may be suitably configured to communicate with some or all of the communications satellites 108 in one or more of the illustrated orbits. Similarly, the communications terminal 100 may be configured to communicate with communications satellites 108 in one or more available satellite communications band.

With reference to FIG. 1B, it will be appreciated that for some geographic locations of a satellite terminal 100, and for some orientations of the satellite antenna 102, a portion of the field of view of the satellite antenna 102 may be blocked or the strength of the beam and corresponding communications link(s) may be compromised (attenuated). Current or future blockage or attenuation of beams may be taken into account in the operation of the satellite communications terminal 100.

Some communications links 110′ between the satellite terminal 100 and the satellites 108′ are unaffected by blockage or substantial attenuation.

FIG. 1B gives the example of a building 190 blocking two communication satellites 108″ that would otherwise be visible to satellite terminal 100. That is, when communications links 110″ are directed towards the locations of blocked satellites 108″, no signal can be transmitted between the satellites 108″ and satellite terminal 100.

FIG. 1B also gives the example of in which intervening weather conditions (e.g. a weather system 192 dropping heavy rain) may significantly attenuate the strength of the communications link 110″′ transmitted between the satellite terminal 100 and the respective satellite 108″′. Similarly, the strength of a communications link may be attenuated when the satellite antenna 102 is inclined further away from the respective communications satellite.

The satellite communications terminal 100 may also communicate information through a terrestrial communications link. The terrestrial communications link may be a Wi-Fi™ communications link 122 (wireless network protocol based on the IEEE 802.11 family of standards) with a Wi-Fi antenna 120. Additionally or alternatively, the terrestrial communications link may be a broadband cellular network communications link 126 (e.g. a 5G network communications link) with a cellular network antenna 124.

The communications terminal 100 identifies all of the communications links 110, 122, 126 that are available to it. The properties of each communications link 110, 122, 126 are assessed to determine one or more respective characterising link parameters. For example, each communications link 110, 122, 126 may be assessed with respect to its available bandwidth (transmission throughput and receiver throughput), latency, signal strength, connection point on the ground, network type, whether encrypted and whether the network is shared, private, dedicated, open or closed. As well as determining current characterising link parameters, future characterising link parameters may be predicted, for example being based upon one or more of weather conditions that attenuate communications links, blockage of at least part of the field of view of the satellite communications terminal, predicted movement of the satellite communications terminal, predicted movement of communications satellites, and prior communications link experience.

The assessment of the communications links 110, 122, 126 may be undertaken by a network element (e.g. a network controller 130) with which the satellite communications terminal 100 is in communication, for example where all of the available communications satellites 108 are in a single satellite communications network. The assessment of the communications links 110, 122, 126 may be undertaken by the satellite communications terminal 100 (or by a higher-level network orchestrator), for example where the satellite communications terminal 100 is in communication with available communications satellites 108 in different satellite communications networks.

For different communications link types, Table 1 shows an exemplary matrix of link parameters characterising several technical features, and suitable technical applications for each type of communications link.

TABLE 1

| | Communications Link Type | | | | | | |
|---|---|---|---|---|---|---|---|
| | Terrestrial | Terrestrial | Ka/Ku | Ka | Ku | Ka | HTS |
| Parameter | Wi-Fi | cellular 4G/5G | LEO | MEO | GEO | GEO | GEO |
| Latency | Low | Lowest | Low | Medium | High | High | High |
| Rx | Low to Very | Low to | Low to | Medium | Low | Medium | High |
| Throughput | High | High | Medium | to High | | | |
| Tx | Low to Very | Low to | Medium | Low to | Low | Low | Medium |
| Throughput | High | High | to High | Medium | | | |
| Power | Lowest | Low | Medium | High | High | Highest | Highest |
| Consumption | | | | | | | |
| $/Mbit | Lowest | Low | Med | Medium | High | Medium to | Medium |
| | | | | to High | | High | |
| Availability/ | Lowest | Low | Low | Medium | High | High | High |
| Reliability | | | | | | | |
| Best-fit | Whenever | Whenever | Voice/ | Web | Multicast, | Bulk | Streaming |
| Application | available and | available and | video | browsing | Critical | downloads | |
| | available | available | calling, | | data | and data | |
| | throughput | throughput | gaming | | transfers | transfers | |
| | and link | and link | | | | | |
| | stability meets | stability meets | | | | | |
| | requirements | requirements | | | | | |

The assessment of link parameters concerning one or more of the availability and reliability of a communications link, the transmission throughput, the reception throughput, and the power consumption may additionally take into account one or more of weather conditions that attenuate communications links, blockage of at least part of the field of view of the satellite communications terminal, predicted movement of the satellite communications terminal, predicted movement of communications satellites, and prior communications link experience.

For example, the satellite communications terminal 100 or another network entity in the communications network (e.g. the network controller 130) may receive a weather model of current and predicted weather data, at the present location and predicted future locations of the satellite communications terminal 100. The weather model may contain data on the current and predicted weather conditions in relevant geographic locations. The weather model may be correlated with the current location of the satellite communications terminal, and the predicted location for a mobile satellite communications terminal, to determine communications links that may be significantly attenuated by present and future weather conditions. For example, heavy rainfall 192 on the line-of-sight path between the satellite communications terminal 100 and a communications satellites 108″′ may significantly attenuate the corresponding communications link 110″′. The predicted route of a mobile satellite communications terminal 100 and the predicted movement of the communications satellites may be correlated with the weather model in determining the effect of weather on the beam and associated communications links of the satellite communications terminal 100. Using the weather model to predict the attenuation of communications links due to weather conditions may enable enhanced performance in prioritising the use of communications links for different types of data traffic.

The satellite communications terminal 100 may receive an input with, or may determine, the geographical location of the satellite communications terminal. The geographic location may be determined using an onboard receiver for a Global Navigation Satellite System (GNSS) such as the Global Positioning System (GPS). Other techniques for determining a location of the satellite antenna 102, for instance terrestrial positioning systems and inertial measurement units, will be well known to the skilled person.

The satellite communications terminal 100 (e.g. memory 106) or another network entity in the communications network (e.g. the network controller 130) may build or receive a blockage model of satellite blocking (or satellite visibility) at the present location or across a relevant geographic area, which is built up using data from the satellite communications terminal, other satellite communications terminals, or both, based upon current and previous blockage experience. For example, the model of satellite blocking (or availability) may include information about the blockage of parts of the field of view of a satellite antenna 102 in particular geographic locations by buildings, trees, bridges and tunnels, hills and other blocking terrain, which may then be correlated with the present and predicted location of the satellite communications terminal. The blockage model may include information about the present and predicted locations of communications satellites (e.g. from ephemeris data and/or from the satellite communications terminal or other satellite communications terminals scanning the sky for communications satellites), enabling correlation of satellite locations with fields of view of the satellite communications terminal. The blockage model may include information about the present and predicted locations of interfering satellites producing interference signals that affect performance of communications links of the satellite communications terminal 100 with communications satellites, which may effectively block part of the field of view of the satellite communications terminal. Predicted blockage (or availability) of communications links to communications satellites at the present and in the future may then be used to inform the suitability of those communications links for use with different types of data traffic. For example, signal interruption by movement of the satellite communications terminal behind a building or under a bridge may be acceptable for the transfer of a large data file but unacceptable for a video or voice call, informing corresponding routing decisions. The predicted route of a mobile satellite communications terminal 100 and the predicted movement of the communications satellites may be correlated with the blockage model in determining blockage (or availability) of the beam and associated communications links of the satellite communications terminal 100.

The satellite communications terminal may receive or generate a signal indicating the present time, for example from an internal clock or by extraction from a signal received from a communications satellite.

In the case of a mobile satellite communications terminal 100 mounted on a vehicle, the satellite communications terminal 100 or another network entity in the communications network (e.g. the network controller 130) may receive an input of the vehicle's planned route, and may receive an input of a road conditions model. The road conditions model may include speed limits on different roads, may include current and/or predicted traffic speeds on roads in the relevant geographic area, may include speed limitations of the vehicle on which the satellite communications terminal is mounted, and may include topographic data and road terrain data (e.g. altitude and camber of the road, which may affect the satellite blockage and communications link strength). The satellite communications terminal 100 or other network entity may use the road conditions model to predict the vehicle's passage along the planned route. The vehicle's predicted passage along the planned route may be correlated with a blockage model (of communications satellite blockage or availability) to inform which communications links are predicted to blocked (or available) at different locations during passage along the planned route. The vehicle's predicted passage along the planned route may also be correlated with a weather model to inform which communications links are predicted, along the planned route, to be attenuated by weather conditions.

The satellite communications terminal 100 (e.g. memory 106) or another network entity in the communications network (e.g. the network controller 130) may build or receive a historic link performance model of communications link performance for a relevant geographic area. The historic performance model may document locations and times in which communications links were available or unavailable for the satellite communications terminal 100 or for other satellite communications terminals in the same location previously. In particular, it may be valuable to be aware of a location or time in which a communications link was unexpectedly unavailable (or available) in contrast to what was predicted based upon other parameters of the communications link. For example, a communications link may have previously been unexpectedly unavailable at a particular location if it was blocked by a newly constructed building or bridge, or foliage growth, that has not already been incorporated into the blockage model. The historic link performance model may enable the processor 104 to benefit from learning on the prior successes and failures of the satellite communications terminal 100 and/or other satellite communications terminals in the communications network, including when a prior communications link decision was subsequently found to be an incorrect decision. The historic link performance model may enable enhanced performance in prioritising the use of communications links for different types of data traffic (for example, informing whether a particular communications link is suitable for video or voice data traffic).

The historic link performance model may include a record of successful combinations of communications links at a particular geographical location, for example recording those combinations that enabled enhanced resilience of data transmission at particular locations. The historic link performance model may include a record of variations of communications link performance at different times of day. The predicted route of a mobile satellite communications terminal 100 may be correlated with the historic link performance model in predicting success or failure of combinations of communications links of the satellite communications terminal 100.

FIG. 2 illustrates a method of operating the satellite communications terminal 100 of FIG. 1 to transmit a composite data stream 140 through a plurality of different communications links 110, 122, 126, in this example being two different satellite communications links 110A, 110B. The composite data stream 140 is received by the processor 104, which separates the composite data stream 140 into subsidiary data streams 144A, 144B.

The composite data stream 140 is separated according to one or more respective characterising data stream parameters of each subsidiary data stream 144A, 144B, being the class (type) of data, required bandwidth, required latency, requirement for encryption and data priority. In an example, the composite data stream 140 is separated into subsidiary data streams 144A, 144B based upon a characterising data stream parameter of their data type, where the composite data stream 140 comprises an audio communications data stream and a document transfer data stream.

Both the identification of the class of data and the transmission over different communications links may be performed by the communications terminal 100. Alternatively, functionality may be split. For example, a piece of user network equipment (e.g. a network controller 130) may perform the identification of the data class and represent the class with Ethernet QOS identifiers or VLAN tagging, which the satellite communications terminal 100 then uses to assign the corresponding data to different communications links as they are available.

The processor 104 then determines which of the available communications link 110A, 110B is the most suitable for transmitting each of the subsidiary data stream 144A, 144B, based upon the characterising data stream parameters of the subsidiary data streams 144A, 144B and the characterising link parameters of the available communications links 110A, 110B.

Determination of how to allocate the subsidiary data streams 144A, 144B is undertaken by the processor 104 in response to data allocation protocols stored within the satellite communications terminal 100 (e.g. within the memory 106).

The data allocation protocols may be fixed and pre-determined, or the data allocation protocols may be reconfigurable in response to past and predicted communications link performance.

The data allocation protocols may be determined and reconfigurable by artificial intelligence (also referred to as machine learning, cognitive system, or manually constructed logic rules) by an artificial intelligence (AI) module 105 and/or an AI module 131 providing an automated decision-making system (ADMS) and incorporating machine learning. In those embodiments described herein referring to AI modules 105, 131, it should be appreciated that one or both of the AI modules 105, 131 may be included and when both are included they may be operated in combination or independently of each other. The AI module 105, 131 may determine the data allocation protocols applied by the processor 104 based upon the past, present and predicted performance of the communications links, which may include being informed by one or more of a weather model, a blockage model, a road conditions model, and a historic link performance model. The AI module may use the geographical location of the satellite communications terminal (e.g. from a global positioning system) and knowledge of the time in correlating received information to determine the data allocation protocols.

The use of the AI module 105, 131 provides enhanced performance for recognising patterns within the very large volume of data points arising through operation of the satellite communications terminal 100 in accordance with the present methods, not least when used with multiple communications links (e.g. used with multiple beams). The AI system may enable enhanced identification of inferences and predictions of actions and state changes, and compensation for incomplete data.

The data allocation protocols may determine a program of communications link usage across a period of time, or along the passage of a planned route for a mobile satellite communications terminal, and the AI module 105, 131 may update the data allocation protocols and consequent program based upon updated information received (e.g. based upon updates of one or more of the weather model, blockage model, road conditions model, and historic link performance model, and based upon deviations from the anticipated passage along the planned route).

In the case that information about a communication link is missing, the AI module 105, 131 may complete the missing information based upon extrapolation from historic information about past performance of communications links in similar scenarios.

Predicting loss (or attenuation) of a communications link may enable pre-emptive switching between communications links before an existing communications link is dropped (broken). Establishing a new communications link after an existing communications link has been dropped may introduce a delay into data transmission, which may be avoided by pre-emptive switching between communications links.

Optionally, the data allocation protocols may not enable a change in the data allocation to different communications links solely based upon predicted weather data, due to the limited temporal and spatial accuracy of predicted weather data. However, the signal to noise ratio (SNR) of signals transmitted by the communications link may be monitored and correlated with predicted weather data, providing increased confidence in the predicted weather data when it corresponds with a change in the SNR, e.g. a deterioration in SNR correlates with weather data predicting reduced communications link transmission. Accordingly, when weather data predicts a change in respective communications link performance, the data allocation protocols may enable a change in the allocation of data to communications links when there is additionally a corresponding change in the SNR.

The AI module 105 may be provided within the processor 104 of the satellite communications terminal 100 or the AI module 131 may be provided within another network entity (e.g. with the network controller 130). Where the AI module is located outside the satellite communications terminal 100, the AI module may regularly or periodically update the decision-making protocols of the satellite communications terminal 100.

Separating composite data stream 140 into subsidiary data streams 144A, 144B that are transmitted by the most suitable of the available communications links enables enhanced transmission performance, for example, reducing latency in video/voice communications and enhancing average data speed for transmission of large data files. Separating the composite data stream into a plurality of subsidiary data streams that are simultaneously transmitted by different communications links (e.g. to different receivers, which may be simultaneous transmission to a plurality of communications satellites) may enhance total data throughput.

Additionally, separating into separate subsidiary data streams increases communications link diversity, and so increases resilience. With a plurality of different available communications links, the failure of any one communications link does not result in the complete failure of all communications. Instead, traffic transmission or reception of the subsidiary data streams 144A, 144B can be continuously reprioritized and reallocated between different communications links in response to real-time changes in the communications link conditions, and in response to predicted changes in communications link conditions. In that way, the decision on the best-available communications link may consider not only the presence of a given communications link, but also the expected stability of that communications link. The presence of multiple simultaneous communications links then increases the resilience of the overall communications system, since no one failure stops all of the communications from occurring.

For example, a communications link may be predicted to be unavailable (or available) for a period during the passage along a planned route of a vehicle on which the satellite communications terminal is mounted. This prediction then may inform the choice of communications links used, and the allocation of data streams to those communications links. For example, video or voice calls may not be allocated to communications links for which an interruption is predicted. In a further example, it may be acceptable for large file transfers may be allocated to communications links for which a limited period of interruption is predicted, if the data throughput or cost is otherwise acceptable. Similarly, a corresponding communications link may not be established, if it is predicted to be available only for a short period (e.g. a cellular communications link might become available only briefly in a gap between the shadow of two hills).

In an example, the processor 104 identifies that a Ka/Ku LEO communications link 110A and a Ka GEO communications link 110B are available, and the processor 104 identifies that the composite data stream 140 contains a video call and the transfer of a large file. The processor 104 separates the composite data stream 140 into a first subsidiary data stream 144A for the video call data, and a second subsidiary data stream 144B for the large data file. The processor 104 determines the most suitable communications link for the first subsidiary data stream 144A and accordingly transmits it through the available Ka/Ku LEO communications link 110A. The processor 104 determines the most suitable communications link for the second subsidiary data stream 144B and accordingly transmits it through the available Ka GEO communications link 110B.

In a further example, where the communications terminal 100 is installed onboard a sea going vessel, a Wi-Fi communications link 122 or broadband cellular network communications link 126 (e.g. a 4G or 5G network communications link) may not be available whilst on the open sea, but may become available when the vessel returns from the open sea to a harbour. When returning to harbour, switching data streams away from satellite transmission to one or both of a Wi-Fi communications link and a broadband cellular network communications link may reduce data transmission costs. However, in the event that the requested traffic exceeds the available bandwidth of the Wi-Fi communications link and/or broadband cellular network communications link, some (or all) of the traffic may also be routed over one or more satellite communications links.

The factors affecting each communications link and class of traffic in each data stream may advantageously be balanced. Although most classes of traffic are benefited by and enjoy low-latency, a high-latency-capable traffic class would not be excluded from a low-latency communications link. Instead, the processor would continually evaluate and re-order the assignment of different data classes to the available communications links based on the current data stream classes and communications link conditions.

The operation of the satellite communications terminal (e.g. satellite terminal) to analyse a composite data stream to identify separate subsidiary data streams and characterising data stream parameters, to identify a plurality of communications links and characterising link parameters, and to apportion (allot) subsidiary data streams to the communications links, based upon their respective data stream parameters and link parameters, may be in response to executable instructions stored in a computer-readable storage medium (memory 106).

In another example, the satellite antenna 102 is selectable between a plurality of performance modes. The satellite antenna 102 may be operable in at least first and second performance modes, in which the second performance mode has a higher data throughput and consumes more power than the first performance mode. The satellite antenna 102 may be selectable between more than two performance modes with different data throughputs and with power consumptions that increase with data throughput.

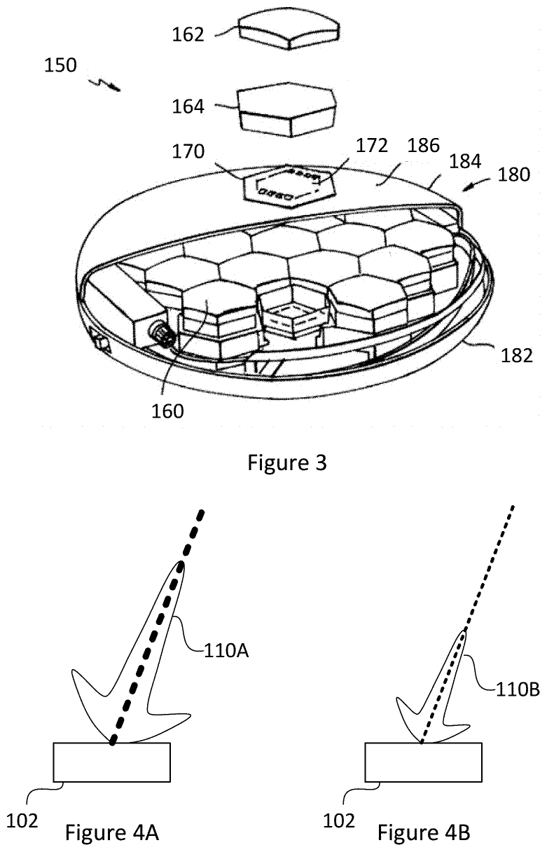

In an example, the satellite antenna 102 may be lens antenna array, for example being the multiple beam phased array antenna having a lens array 150, as shown in the partially exploded and cut-away view of FIG. 3. The lens array 150 has a plurality of lens sets 160. Each lens set 160 includes a lens 162, spacer 164 and feed set 170 which has multiple feed elements 172, as shown by the one exploded lens set 160 for purposes of illustration. In use, the selection of different feed elements 172 in each lens set 160 enable signals to be transmitted through the lens 162 in different directions. The spacer 164 separates the lens 162 from the feed set 170 to match the appropriate focal length of the lens. The spacer 164 may be made out of a dielectric foam with a low dielectric constant. In other examples, the spacer 164 includes a support structure that creates a gap, such as an air gap, between the lens 162 and the feed set 170. In further examples, the lens set 160 does not include the spacer 164. The feed element 172 may be constructed as a planar microstrip antenna, such as a single or multilayer patch, slot, or dipole, or as a waveguide or aperture antenna. While depicted as a rectangular patch on a multilayer printed-circuit board (PCB), the feed element 152 may have an alternate configuration (size and/or shape).

As shown, the lens array 150 may be situated in a housing 180 having a base 182 and a cover or radome 184 that completely encloses the lens sets 160, feed sets 170, and other electronic components. In some implementations, the cover 184 includes an access opening for signal wires or feeds. The housing 180 is relatively thin and can form a top surface 186 for the lens array 150. The top surface 186 can be substantially planar or slightly curved.

Although exemplary operation has been described in relation to a satellite antenna 102 that is a lens antenna array, the person of ordinary skill will appreciate that the method of operating a satellite terminal may similarly be used with other satellite antennae.

The satellite antenna 102 of the satellite communications terminal 100 may be a phased array or other electronically steered antenna (ESA) producing a single beam or a plurality of beams. The beam (and corresponding communications links), or more than one beam, may have different performance modes having different throughputs and corresponding power consumptions. The is at least a lower performance mode and a higher performance, in which the higher performance mode has a higher throughput and a higher power consumption than the lower performance mode.

In the case of a phased array antenna, for different performance modes the number of array elements in the array, the drive level of the enabled elements, or the gain or power settings of other subsystems in the RF chain (e.g., buffer amplifiers, mixers, or IF drive) may vary, with a higher performance mode exciting a larger number of array elements in the array or driving a given number of array elements or other subsystems in the RF chain at a higher gain or power level, providing a higher throughput and using a correspondingly higher power consumption.

FIGS. 4A and 4B illustrate transmission of a beam from a satellite antenna of a satellite communications terminal with different beam strengths. As shown respectively in FIGS. 4A and 4B, the beam strength and receiver sensitivity of the satellite antenna 102 may be selected between different performance modes, with a greater beam power and/or receiver sensitivity (second performance mode) used to transmit and receive with a stronger beam 110A, enabling a higher data throughput, and conversely having the beam power and/or receiver sensitivity reduced (first performance mode) to provide a less powerful beam 110B, when the data throughput requirement of the satellite terminal 100 reduces. Switching between beam powers may enable the accommodation of spikes in demand for the transmission of data from the satellite terminal while maintaining an overall low average power consumption in an energy-constrained or off-the-grid environment. Switching between beam powers may enable compensation for attenuation of the beam (communications link). For example, heavy rainfall 192 on the line-of-sight path between the satellite communications terminal 100 and a communications satellites 108″′ may significantly attenuate the corresponding communications link 110″′, as illustrated in FIG. 1B, and may be compensated for by increasing the beam power. Similarly, the strength of a communications link may be attenuated when the satellite antenna 102 is inclined away from the respective communications satellite (e.g. when the satellite communications terminal is on a vehicle driving on a cambered or otherwise inclined road, or as the communications satellite moves across the field of view of the satellite antenna), which may also be compensated for by increasing the beam power.

In the example of a lens array 150, the beam strength of the satellite antenna 102 may be selected by controlling the number and arrangement of operative feed sets 170 in the lens array 150, for example with a larger number of feed elements per lens being operated to provide a higher power and/or sensitive beam and higher data throughput. For example, subject to data throughput demand, the lens array may operate with 30 to 80 operative lens and feed sets in the lens array. For example for low data throughput from the lens array, each operative lens may operate with only two feeds enabled per lens per beam. In average or high data throughput cases, four feeds may be enabled for each lens per beam.

The decision of the satellite communications terminal 100 to transmit with a higher data throughput or operate with a higher receiver sensitivity may be based upon a measured link condition of the satellite communications link 110 with the communications satellite. Examples of such a measured link condition may be a measured signal to noise plus interference ratio, or an estimated uplink or downlink throughput, or the current MODCOD (modulation and coding) in use, by the forward or reverse communications links, by the modem.

For a terminal with access to a certain amount of spectral bandwidth, the signal strength is a determining factor in which MODCODs the modem can use without transmission errors.

The processor of the satellite communications terminal can identify, as it is processing the network traffic, that the requested traffic is greater than the capacity of the current communications link, and thus trigger a decision to increase the communications link capacity by changing to a higher-performance antenna operational mode. The current link capacity can be determined empirically by measuring the traffic successfully transmitted through the modem through the TCP protocol, or analytically by querying the MODCOD and communications link spectral bandwidth used by the modem.

Alternatively, the decision of the satellite communications terminal 100 to transmit with a higher data throughput may be based upon receiving an indication (e.g. through the satellite network) of communications link congestion on the satellite communications link 110, which may include a backlog of data to be transmitted to or received from the satellite, for example receiving an indication that other satellite communications terminals are holding a backlog of data to be transmitted to the receiver communications satellite 108 of the available communications link 110. The use of a higher performance beam may enable a higher priority transmission to the communications satellite 108.

In a further alternative, the decision to switch to a different performance mode with a higher (or lower) throughput may be in response to a user override instruction.

In a further alternative, the decision of the satellite communications terminal 100 to transmit with a lower data throughput at a moment in time may be based upon a system constraint to maintain average power consumption below a threshold level or to meet an average power level (e.g. 500W beam power), for example to preserve limited power supply resources for operation of the satellite terminal, or to limit the maximum power level.

In this way, the processor (controller) 104 is required to balance current, future, and past communications traffic volume and throughput requirements with the available power supply to the satellite communications terminal 100. For example, in the case of a satellite communications terminal that is powered by a dedicated set of battery-backed solar panels, there is a finite energy that can be expended per 24-hour cycle. Based on the capacity of the batteries and the solar panels, there will be an average effective power that the satellite communications terminal (along with any other powered equipment) may be allowed to draw over the course of a day to prevent depleting the batteries, subject to appropriate safety margins and accounting for times of low solar power availability. In this situation, the terminal would operate by default in a low-power mode that is significantly below the 24 h average power limit for the satellite communications terminal.

In that way, momentary bursts of high-throughput data requests can be accommodated by temporarily increasing the performance of the terminal, then dropping back to a low-power state. On a given day, if the actual demands for data throughput are higher than average and the total consumed energy by the terminal approaches the threshold, the terminal processor may change the thresholds for dynamically increasing performance at the cost of power consumption, to limit the increase in power and ensure that the charge of the batteries does not drop below a set threshold.

Satellite communications modems (within a satellite communications terminal 100) are conventionally designed to operate at the best available link performance mode, regardless of the actual demand or usage of data throughput. Modems are configured to transmit continuously in whatever frequency band or time slot is allocated, and if there is no useful data to transmit, the modem will fill the spaces with null data that is then removed at the receiver. The satellite communications terminal, by communicating and coordinating with the modem and the hub, can make note of situations where the modem does not have sufficient data to saturate the given communications link, and the processor may then decrease the antenna beam transmit power or receiver sensitivity to bring the current data demand (traffic volume), the satellite resources, and the satellite communications terminal performance and power consumption into balance. Some modems, such as time division multiple access (TDMA) modems, work to balance the data demands to an individual terminal by adjusting the duration and frequency of time slots allocated to a given terminal in a way that matches the resources of the communications satellite and satellite communications terminal, but this capability to adjust the power consumption of the satellite communications terminal is not accounted for in a TDMA system, and is not available at all in conventional single channel per carrier (SCPC) communications links.

Operation of the communications terminal 100 to select between the plurality of performance modes may be in response to executable instructions stored in a computer-readable storage medium (memory 106).

The selection of a performance mode may be subject to a temporary or indefinite end-user override for particular situations. For a case where the short bursts of latency-sensitive high-bandwidth network traffic are required, the satellite communications terminal may be configured to remain in a high-performance mode, since adjusting the antenna performance will impose some delay in the modem until the increased performance is available. Similarly, a user may provide an override that forces the lowest possible performance mode to be used in a situation where resupply of generator fuel is difficult and expensive, but continuous communications even, at a low rate, is required.

Determination of how to select between different performance modes is undertaken by the processor 104 in response to performance mode selection protocols stored within the satellite communications terminal 100 (e.g. within the memory 106).

The performance mode selection protocols may be fixed and pre-determined, or the performance mode selection protocols may be reconfigurable in response to past and predicted communications link performance.

The performance mode selection protocols may be determined and reconfigurable by an artificial intelligence (AI) module 105, 131 providing an automated decision-making system (ADMS) and incorporating machine learning, similarly for the above described data allocation protocols. The AI module may determine the performance mode selection protocols applied by the processor 104 based upon both the present performance of the communications links, and based upon past and predicted performance of the communications links, which may include being informed by one or more of a weather model, a blockage model, a road conditions model, and a historic link performance model, as were described above in relation to the data allocation protocols. The AI module may use the geographical location of the satellite communications terminal (e.g. from a global positioning system) and knowledge of the time in correlating received information to determine the performance mode selection protocols.

The performance mode selection protocols may determine a program of performance mode selection across a period of time, or along the passage of a planned route for a mobile satellite communications terminal, and the AI module 105, 131 may update the performance mode selection protocols and consequent program based upon updated information received (e.g. based upon updates of one or more of the weather model, blockage model, road conditions model, and historic link performance model, and based upon deviations from the anticipated passage along the planned route).

Predicting attenuation of a communications link (beam) may enable pre-emptive switching between performance modes before the data throughput of the existing communications link drops below an acceptable level. Switching to a higher performance mode of the communications link after the communications link has dropped beneath an acceptable data throughput may introduce a delay or interruption to data transmission, which may be avoided by pre-emptive switching between performance modes.

Optionally, the performance mode selection protocols may not enable switching between performance modes solely based upon predicted weather data, due to the limited temporal and spatial accuracy of predicted weather data. The signal to noise ratio (SNR) of signals transmitted by the communications link may be monitored and correlated with predicted weather data, providing increased confidence in the predicted weather data when it corresponds with a change in the SNR, e.g. a deterioration in SNR correlates with weather data predicting reduced communications link transmission. Accordingly, when weather data predicts a change in respective communications link performance, the performance mode selection protocols may lead to a change in the performance mode when there is additionally a corresponding change in the SNR. Further, the extent to which the performance mode may be revised (e.g. change in beam power) may correspond with the extent to which the SNR changes.

As described in relation to the data allocation protocols, the AI module 105 may be provided within the processor 104 of the satellite communications terminal 100 or the AI module 131 may be provided within another network entity (e.g. with the network controller 130). Where the AI module is located outside the satellite communications terminal 100, the AI module may regularly or periodically update the decision-making protocols of the satellite communications terminal 100.

When combined with maintaining simultaneous connections to a plurality of communications links, the dynamic performance mode selection (determining whether to communicate with the first communications satellite in the first or second performance mode) can become even more flexible. The performance modes used for different communications links may be different, allowing a first communications link to be operated in a low power mode for communications link resilience while carrying little traffic, and allowing a second communications link to operate in a high performance mode and carry the majority of the traffic. Increasing the throughput of an existing communications link by increasing the terminal performance (receiver sensitivity or transmit beam power) is a much faster process by which to respond to changes in communications requirements than by waiting for a spike in demand (traffic volume) before establishing a second communications link. Decisions as to data throughput demands and which communications link or links to switch to a higher or lower performance mode may be made to account for how much traffic in different modes or categories is required, or to account for a comparison of how much additional power is required to achieve a given increase in satellite antenna throughput. For example, shifting a LEO communications link from low to high power mode may increase performance from 100 to 200 Mbps, while increasing a GEO connection from the same terminal from low to high power mode may only yield a 10 to 20 Mbps increase in throughput. There may be additional constraints on the performance of a communications link independent of the terminal performance, for example, being a constraint on the throughput available at the hub (the other side of the communications link from the satellite communications terminal) when traffic congestion situations arise, which may mean that increasing the satellite antenna performance on a communications link may not yield increases in throughput at one time, but may at another time, even for the same satellite antenna and communications satellite. These inputs, both for power of a single communications link and for power that must be shared between multiple communications links for the same satellite communications terminal may be accounted for by the satellite communications terminal when setting power and performance modes.

The satellite communications terminal 100 may determine a transmission indicator for the or each communications link that is indicative of one or both of: the transmission performance of the communications link; and a transmission comparator that is indicative of correspondence between predicted transmission performance and determined transmission performance of the communications link.

The transmission indicator(s) may be recorded by the memory 106 of the satellite communications terminal 100. The transmission indicator may be shared with another network entity of the satellite communications network in which the satellite communications terminal 100 operates, for example being shared with and stored by the network controller 130.

The transmission indicator(s) may be used to build and/or update one or both of the blockage model and the historic link performance model. For example, new data on the blockage or attenuation of communications links for a particular geographical location or field of view of the satellite antenna of the satellite communications terminal may be updated.

Storing the transmission indicator(s) within the satellite communications terminal may enable the satellite communications terminal to improve future operational performance, for example by avoiding replicating drops in communications links or reduced performance from communications link attenuation. Similarly, sharing the transmission indicator(s) with the communications network, and onwards to other satellite communications terminals may enable other satellite communications terminals to improve future operational performance, for example by avoiding replicating drops in communications links or reduced performance from communications link attenuation.

The figures provided herein are schematic and not to scale.

Throughout this specification, the words “comprise” and “contain” and variations of them mean “including but not limited to”, and they are not intended to (and do not) exclude other components, integers or steps. Throughout this specification, the singular encompasses the plural unless the context otherwise requires. In particular, where the indefinite article is used, the specification is to be understood as contemplating plurality as well as singularity, unless the context requires otherwise. Throughout this specification, the term “about” is used to provide flexibility to a range endpoint by providing that a given value may be “a little above” or “a little below” the endpoint. The degree of flexibility of this term can be dictated by the particular variable and can be determined based on experience and the associated description herein.

Features, integers or characteristics described in conjunction with a particular aspect or example of the invention are to be understood to be applicable to any other aspect or example described herein unless incompatible therewith. All of the features disclosed in this specification, and/or all of the steps of any method or process so disclosed, may be combined in any combination, except combinations where at least some of such features and/or steps are mutually exclusive. The invention is not restricted to the details of any foregoing examples. The invention extends to any novel feature or combination of features disclosed in this specification. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The reader's attention is directed to all papers and documents which are filed concurrently with or previous to this specification in connection with this application and which are open to public inspection with this specification, and the contents of all such papers and documents are incorporated herein by reference.

1. A method of operating a satellite communications terminal, the method comprising:
analysing data to be communicated through the satellite communications terminal to identify separate data streams and determine a data stream parameter characterising each data stream;
identifying a plurality of communications links available through the satellite communications terminal comprising a satellite communications link and one or more further communications links;
determining a link parameter characterising each available communications link;
selecting at least two communications links from the available communications links and establishing or maintaining simultaneous connections to each selected communications link; and
transmitting a first data stream through a first selected communications link and transmitting a second data stream through a second selected communications link;
wherein the selection of at least two communications links is based on the data stream parameters characterising the first and second data streams and the link parameters characterising the available communications links.

2. A method according to claim 1, wherein the selection of the at least two communications links is based on predicted availability of the available communications links or a predicted value of a link parameter characterising an available communications link.

3. A method according to claim 1, wherein each further communications link is a satellite communications link.

4. A method according to claim 1, wherein each further communications link is a terrestrial communications link.

5. A method according to claim 1, wherein the data stream parameter characterising each data stream comprises one or more of type of data, required bandwidth, required latency, requirement for encryption and data priority.

6. A method according to claim 1, wherein the link parameter characterising each available communications link comprises one or more of available bandwidth, latency, signal strength, connection point on the ground, network type, whether encrypted and whether the network is shared, private, dedicated, open or closed.

7. A method according to claim 6, wherein determining the link parameters comprises one or more of assessing:
current and predicted weather conditions that affect communications links;
blockage of at least part of the field of view of the satellite communications terminal;
interference affecting communications link performance;
predicted movement of the satellite communications terminal;
predicted movement of communications satellites; and
prior communications link performance.

8. A method according to claim 1, wherein analysing data to be communicated through the satellite communications terminal to identify separate data streams and to determine a data stream parameter characterising each data stream is performed by a network element with which the satellite communications terminal is in communication.

9. A method according to claim 1, comprising allocating the first and second data streams to the at least two communications links based upon the link parameters and the data stream parameters in accordance with data allocation protocols determined by an artificial intelligence module.

10. A method according to claim 1, wherein a first selected communications link is operated in a first performance mode and a second selected communications link is operated in a second performance mode, wherein the second performance mode has a higher throughput than the first performance mode and consumes more power than the first performance mode.

11. A method according to claim 1, comprising determining a transmission indicator for each of first selected communications link and the second selected communications link that is indicative of one or both of:
the transmission performance of the communications link; and
a transmission comparator that is indicative of correspondence between predicted transmission performance and determined transmission performance of the communications link.

12. A method according to claim 11, wherein the satellite communications terminal is operating within a satellite communications network, and the satellite communications terminal communicates the transmission indicators to a network entity operating within the satellite communications network.

13. A method of operating a satellite communications network, comprising:
performing the method of operating the satellite communications terminal of claim 12;
receiving, by the network entity, the transmission indicators from the satellite communications terminal; and
storing, by the network entity, the transmission indicators.

14. A method of operating a satellite communications network according to claim 13, wherein the network entity is a network controller, and the method further comprising transmitting the transmission indicators to a further satellite communications terminal.

15. A method of operating a satellite communications terminal having a satellite antenna, the method comprising:
controlling the satellite antenna to generate a first beam to communicate with a first communications satellite according to one of at least first and second performance modes, wherein the second performance mode has a higher throughput than the first performance mode and consumes more power than the first performance mode;
wherein the method further comprises determining whether to communicate with the first communications satellite in the first or second performance mode on the basis of one of:
a measured link condition or a predicted link condition for communicating with the first communications satellite;
an indication of link congestion comprising a backlog of data to be transmitted to the first communications satellite;
a constraint to maintain average power consumption below a first threshold; and
a constraint to limit the maximum power level.

16. A method according to claim 15, wherein the measured link condition comprises a signal to noise plus interference ratio.

17. A method according to claim 15, wherein the measured link condition or predicted link condition comprises an estimated uplink or downlink throughput for communicating with the first communications satellite.

18. A method according to claim 17, wherein the satellite communications terminal monitors a volume of requested communications traffic, and
the satellite communications terminal switches from the first performance mode to the second performance mode when the volume of requested communications traffic exceeds the capacity of the first performance mode.

19. A method according to claim 15, wherein the satellite communications terminal switches from the first performance mode to the second performance mode based upon performance mode selection protocols determined by an artificial intelligence module.

20. A method according to claim 15, wherein the satellite antenna comprises a lens antenna array comprising:
a plurality of lens sets, each lens set including:
a lens:
plurality of feed elements aligned with the lens and each configured to direct a signal through the lens in different desired directions;
wherein the second performance mode comprises operating a larger number of feed elements per lens than the first performance mode.

21. A method according to claim 15, wherein the method further comprises the satellite communications terminal communicating with the first communications satellite in a different performance mode from the determined first or second performance mode in response to a user override instruction.

22. A method according to claim 15, comprising determining a transmission indicator for the first beam that is indicative of one or both of:
a transmission performance of the first beam; and
a transmission comparator that is indicative of correspondence between predicted transmission performance and determined transmission performance.

23. A method according to claim 22, wherein the satellite communications terminal is operating within a satellite communications network, and
the satellite communications terminal communicates the transmission indicator to a network entity operating within the satellite communications network.

24. A method of operating a satellite communications network, comprising:
performing the method of operating the satellite communications terminal of claim 15;
receiving, by the network entity, the transmission indicator from the satellite communications terminal; and
storing, by the network entity, the transmission indicator.

25. A method of operating a satellite communications network according to claim 24, wherein the network entity is a network controller, and the method further comprising transmitting the transmission indicator to a further satellite communications terminal.

26. A computer-readable storage medium having computer-readable program code stored therein that, in response to execution by a processor, cause the processor to perform the method of claim 1.

27. A satellite communications terminal comprising:
a satellite antenna;
a processor; and
a memory storing executable instructions that, in response to execution by the processor, cause the processor to perform the method of claim 1.
